(19) United States
(12) Patent Application Publication
(10) Pub. No.: US 2026/0071064 A1
(43) Pub. Date: Mar. 12, 2026

(54) PROCESSABLE POLYVINYL CHLORIDE COMPOUNDS

(71) Applicant: Galata Chemicals, LLC, Jersey City, NJ (US)

(72) Inventors: Peter FRENKEL, Danbury, CT (US); Chris TURNBULL, Barrie (CA)

(21) Appl. No.: 19/102,941

(22) PCT Filed: Aug. 15, 2023
(86) PCT No.: PCT/US2023/030249

§ 371 Date: Feb. 11, 2025

Related U.S. Application Data
(60) Provisional application No. 63/398,058, filed on Aug. 15, 2022.

(51) Int. Cl. C08L 27/06; C08K 5/00

(52) U.S. Cl. CPC C08L 27/06; C08K 5/005; C08L 2201/08

(57) ABSTRACT

A stabilized compound comprising: a) a resin comprising PVC or its copolymers; b) 0.1 to 10 parts by weight of a styrene-co-acrylonitrile (SAN) processing aid comprising nitrogen based on the weight of the resin; and c) 0.1-10 parts by weight of a mixed metal heat stabilizer per 100 parts by weight of the resin, the stabilizer comprising a zinc compound and at least one metal compound where the metal is selected from Na, K, Mg, Ca, Sr, Ba, Cd, Al, La, Ce or rare earth metals, based on 100 parts of the resin, wherein an atomic ratio of nitrogen from the SAN processing aid to zinc from the stabilizer in the compound ranges from 0.03 to 300.

### FIELD OF THE INVENTION

The present invention relates to compounds containing polyvinyl chloride (PVC) that are stabilized with mixed metal stabilizers, and contain styrene-co-acrylonitrile (SAN) processing aids. The stabilized compounds exhibit enhanced performance characteristics.

### BACKGROUND OF THE INVENTION

Polyvinyl chloride is one of the most widely used plastics in the world, being employed in such applications as pipes, pipe fittings, films, sheets, flooring, cables, and construction profiles. However, polyvinyl chloride can decompose during processing due to heating, and become damaged because of in-process shear and stress due to prolonged exposure to sunlight that result in discoloration, embrittlement, and loss of HCl. Stabilizers are used to prevent or reduce the thermal degradation and discoloration of polyvinyl chloride due to its exposure to heat and in-process stress and shear that cause dehydrochlorination, auto-oxidation and mechano-chemical chain scission of the polymer and its co-polymers. These stabilizers and their loadings in PVC compounds may also prevent or reduce degradation of the polyvinyl chloride compounds not only during processing, but also during the useful life of finished goods and articles produced from it. There are several major classes of heat stabilizers, such as organotin thioesters, mixed metal stabilizers including combinations of calcium soaps and zinc soaps, as well as barium soaps and zinc soaps, lead stabilizers and cadmium stabilizers. Driven by the importance of stabilizer performance in compounds containing polyvinyl chloride, work has been ongoing to optimize stabilizer compositions for such use.

High molecular weight processing aids (“flow modifiers”) are a key additive used primarily in rigid PVC compounds. It functions as a fusion accelerator/promoter in melting processes and alters melt rheology, increasing the melt elasticity of PVC compounds that are processed via extrusion, molding and/or calendaring compounding steps. They are used for manufacturing most rigid PVC articles, including foams.

Processing aids usually improve the appearance of the finished product. Most of the conventional process aids are co-polymers of methylmetacrylate (MMA) and other acrylate esters. The MMA-based processing aids are known to be used with all main classes of heat stabilizers. There is also a family of processing aids that are styrene-acrylonitrile (SAN) co-polymers which are used in processing rigid PVC compounds. U.S. Pat. No. 2,646,417 discloses the use of SAN processing aids in PVC compounds stabilized with lead stabilizers, cadmium stabilizers, calcium silicate and strontium salicylate. U.S. Pat. No. 2,753,322 discloses the use of SAN processing aids in PVC compounds without any specific description of heat stabilizers. U.S. Pat. No. 2,807,603 describes the use of SAN processing aids in PVC compounds using inorganic polyvalent metal compounds as heat stabilizers with lead stabilizers being preferred. U.S. Pat. No. 2,902,460 teaches the use of SAN processing aids in PVC compounds stabilized with iron oxide. U.S. Pat. Nos. 5,095,083, 5,206,296 disclose the use of SAN processing aids in PVC compounds stabilized with organotin stabilizers.

Nevertheless, a continuing need exists for additive systems that provide improved stability and enhanced processability of PVC compounds and articles. In particular, there is a need for minimizing adverse environmental impacts associated with energy consumption for manufacturing PVC. There is a growing sentiment to restrict or reduce certain mixed metal stabilizes designated as hazardous. Metals that are currently under the regulatory pressure include cadmium and lead, and to a certain extent barium in the final articles. Therefore, reducing the total metal content of mixed metal stabilizers in PVC compounds is critical for reducing the amount of potentially hazardous chemicals in use.

It has unexpectedly been discovered that PVC compounds with incorporated SAN processing aids and stabilized by mixed metal stabilizers fuse/melt faster, enabling the reduction of processing temperature, increase production throughput and require reduced loadings of the processing aids in those compounds.

### SUMMARY OF THE INVENTION

In one embodiment, the present invention relates to a stabilized compound comprising: a) a resin comprising PVC or its copolymers; b) 0.1 to 10 parts by weight of a styrene-co-acrylonitrile (SAN) processing aid comprising nitrogen based on the weight of the resin; and c) 0.1-10 parts by weight of a mixed metal heat stabilizer per 100 parts by weight of the resin, the stabilizer comprising a zinc compound and at least one metal compound where the metal is selected from Na, K, Mg, Ca, Sr, Ba, Cd, Al, La, Ce or rare earth metals, based on 100 parts of the resin, wherein an atomic ratio of nitrogen from the SAN processing aid to zinc from the stabilizer in the compound ranges from 0.03 to 300.

In another embodiment, the present invention relates to a process to prepare a stabilized compound comprising mixing: a) a resin comprising PVC or its copolymers; b) 0.1 to 10 parts by weight of a styrene-co-acrylonitrile (SAN) processing aid comprising nitrogen based on the weight of the resin; and c) 0.1-10 parts by weight of a mixed metal heat stabilizer per 100 parts by weight of the resin, the stabilizer comprising a zinc compound and at least one metal compound where the metal is selected from Na, K, Mg, Ca, Sr, Ba, Cd, Al, La, Ce or rare earth metals, based on 100 parts of the resin, wherein an atomic ratio of nitrogen from the SAN processing aid to zinc from the stabilizer in the compound ranges from 0.03 to 300.

### DETAILED DESCRIPTION OF THE INVENTION

The stabilized compound comprises polyvinyl chloride or its copolymers; 0.1 to 10 parts by weight of at least one SAN co-polymer processing aid based on 100 parts by weight of PVC or its co-polymers; and 0.1 to 10 parts by weight of a mixed metal stabilizer comprising a zinc compound and at least one other metal compound, where the other metal is selected from Na, K, Mg, Ca, Sr, Ba, Cd, Al, La, Ce or rare earth metals, based on 100 parts by weight of PVC or its co-polymers, wherein an atomic ratio of nitrogen (from SAN) to zinc (from the stabilizer) in the compound is 0.03 to 300, preferably from 1.5 to 15.

### SAN Processing Aids

The styrene-co-acrylonitrile processing aids are prepared in the emulsion polymerization process at 60-95° C. It comprises about 71-75% styrene and about 25-29% acrylonitrile. Its molecular weight varies from 1.5×10⁶ to 6.0×10⁶ Daltons, preferably from 2.5×10⁶ to 5.0×10⁶ Daltons. The particle size ranges of the isolated SAN processing aid powders are largely from 45 to 250 microns. Bulk density ranges from 0.30 to 0.40 g/cm³ Examples of SAN processing aids include Blendex 8633 (Medium Molecular Weight processing aid) and Blendex 8635 (High Molecular Weight processing aid) manufactured by Galata Chemicals.

### Mixed Metal Stabilizers

The mixed metal stabilizer comprises a zinc compound and at least one other metal compound, where the other metal is selected from Na, K, Mg, Ca, Sr, Ba, Cd, Al, La, Ce or rare earth metals. Preferably, the mixed metal stabilizer comprises barium compounds and zinc compounds, magnesium compounds and zinc compounds, calcium compounds and zinc compounds, or calcium compounds, magnesium compounds, and zinc compounds.

Preferably, the zinc and other metal compounds are independently selected from carboxylates, overbased carboxylates, glycerolates, oxides, hydroxides, phosphites, perchlorates, basic carbonates, or benzoates, where the carboxylates are independently selected from benzoates, oleates, stearates, palmitates, soyates, tallates, myristylates, hydroxystearates, dihydroxy-stearates, laurates, 2-ethylhexanoates and salts of shorter-chain alkane carboxylic acids.

Preferably, the zinc and other metal carboxylates are independently selected from the zinc, calcium, magnesium, or barium carboxylates of carboxylic acids having 7 to 18 carbon atoms. More preferably, the zinc and metal carboxylates are independently selected from zinc, calcium, magnesium or barium salts of monovalent carboxylic acids such as octanoic, neodecanoic, 2-ethylhexanoic, decanoic, undecanoic, dodecanoic, tridecanoic, myristic, palmitic, isostearic, stearic, 12-hydroxystearic, lauric, behenic, and sorbic acid; and the calcium, magnesium and zinc salts of divalent carboxylic acids, such as oxalic, malonic, succinic, glutaric, adipic, fumaric, phthalic, isophthalic, terephthalic, hydroxyphthalic acid and citric acid. Overbased carboxylates, such as overbased zinc octoate and overbased calcium or barium soaps, are also preferred.

The zinc compound is typically present in the mixed metal stabilizer in an amount up to 25% based on the weight of the mixed metal stabilizer. Preferably, the zinc compound is present in an amount from 0.1% to 10%, based on the weight of the mixed metal stabilizer. The other metal compound is present in the mixed metal stabilizer in an amount up to 35% based on the weight of the mixed metal stabilizer. Preferably, the other metal compound is present in an amount from 0.1% to 15% based on the weight of the mixed metal stabilizer.

The mixed metal stabilizer is present in the compound in an amount of from 0.1 to 10 parts by weight, preferably from 0.01 to 8 parts by weight, and more preferably from 0.05 to 5 parts by weight per 100 parts by weight of the PVC or its copolymers.

It is important to point out that the discovered performance attributes of SAN processing aids in PVC compounds were substantially more pronounced in the presence of the mixed metal stabilizers, and they were less pronounced, when the PVC compounds were stabilized by alkyltin stabilizers, for example.

### Polymer Resin

As employed herein, the term resin is referred to as polyvinyl chloride (“PVC”); it is intended to include both homopolymers and copolymers of vinyl chloride, i.e., vinyl resins containing vinyl chloride units in their structure, e.g., copolymers of vinyl chloride and vinyl esters of aliphatic acids, in particular vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; post-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether, chlorinated PVC (CPVC), and the like.

The PVC can be obtained via polymerization in bulk or in suspension, in emulsion, in micro suspension, or in suspended emulsion.

### Co-Stabilizers

The mixed metal stabilizer compositions can additionally contain co-stabilizers. Co-stabilizers which can be present in the compositions include selected organic compounds, layered lattice compounds (hydrotalcites), alkyltin compounds, zeolites, and mixtures thereof. Such co-stabilizers are well known to those skilled in the art.

### Selected Organic Components

Suitable polyols and other organic components are selected from 1,3-diketones, such as dibenzoylmethane and stearylbenzoylmethane, uracil derivatives, or mixtures thereof. The organic compounds can be used in an amount from 0.01 to 20 parts by weight, preferably from 0.1 to 10 parts by weight and more preferably from 0.1 to 5 parts by weight, based on 100 parts by weight of PVC or its copolymers.

### Layered Hydrotalcites

Examples of hydrotalcites that may be used as co-stabilizers are compounds known to those skilled in the art as shown, for example, in DE 384 35 81, EP 0 062 813 and WO 1993/20135.

Hydrotalcites that can be present in the compositions include those of the general formula: M²⁺₁₋ₓM³⁺ₓ(OH)₂(An^{b-})_{x/b}dH₂O, wherein M²⁺ represents one or more metals from the group Mg, Ca, Sr, Zn and Sn, M³⁺ represents Al or B, An is an anion having the valency n, b is a number from 1 to 2, 0<x<0.5, and d is a number in the range from 0 to 300, preferably in the range from 0.5 to 30. Preferably, An is OH⁻, ClO₄⁻, HCO₃⁻, CH₃COO⁻, C₆HCOO—, CO₃²⁻, (CHOHCOO)₂²⁻ (CH₂COO)₂²⁻, CH₃CHOHCOO⁻, HPO₃⁻ or HPO₄²⁻.

Examples of hydrotalcites are Al₂O₃6MgO CO₂12H₂O (i), Mg_{4,5} Al₂(OH)_{1.3}CO₂ 3.51H₂O (ii), 4MgOAl₂O₃CO₂9H₂O (iii), 4MgOAl₂O₃CO₂6H₂O, ZnO3MgOAl₂O₃CO₂8-9H₂O and ZnO 3MgOAl₂O₃CO₂5-6H₂O (iv). Preferred are types i, ii and iii.

The hydrotalcites can be present in the compound in an amount of from 0.1 to 20 parts by weight, preferably from 0.1 to 10 parts by weight and more preferably from 0.1 to 5 parts by weight per 100 parts by weight of PVC or its copolymers.

### Alkyltin Compounds

When the heat stabilizer composition of the current subject matter contains alkyltin compounds, the alkyltin compound is preferably selected from alkyltin mercaptides, alkyltin carboxylates, alkyltin sulfides or mixtures thereof.

Alkyltin mercaptides may preferably include alkyltin mercaptocarboxylic acid esters and alkyltin 2-mercaptoethylcarboxylates. Preferred examples of liquid alkyltin mercaptocarboxylic acid ester components include mono-alkyltin tris(2-ethylhexyl mercaptoacetate), di-alkyltin bis(2-ethylhexyl mercaptoacetate), dialkyltin bis(ethylene glycol di-mercaptoacetate) and mixtures thereof, where the alkyl group is selected from C₁-C₁₂ linear, branched, or cyclic hydrocarbons. Preferably, the alkyl groups are selected from methyl, n-butyl or n-octyl. The weight ratio of the mono- to dialkyltin mercaptides ranges from 1/99 to 99/1, preferably from 5/95 to 95/5 and more preferably from 5/95 to 50/50.

The alkyl groups in the alkyltin 2-mercaptoethylcarboxylates are preferably selected from C₁-C₁₂ linear, branched, or cyclic hydrocarbons. Preferably, the alkyl groups are methyl or n-butyl. Preferred examples of liquid alkyltin 2-mercaptoethylcarboxylates include dimethyl tin bis(2-mercaptoethyltallate), mono-methyltin tris(2-mercaptoethyltallate), dibutyltin bis(2-mercaptoethyltallate), mono-butyltin tris(2-mercaptoethyltallate) and their mixtures.

Preferably, the alkyltin carboxylates are dialkyltin bis(carboxylate) components that are selected from dialkyltin bis (ethylmaleate), dialkyltin bis(2-ethylhexyl maleate), dialkyltin bis (laurate), dialkyltin bis (neodecanoate), dialkyltin bis(2-ethylhexanoate), dialkyltin bis (oleate), dialkyltin bis(2-ethylhexanoate) or mixtures thereof, where the alkyl group is selected from C1-C12 linear, branched, or cyclic hydrocarbons. Preferably, the alkyl groups are methyl, n-butyl or n-octyl. The dialkyltin bis(carboxylates) may contain mono-alkyltin tris(carboxylates).

When alkyltin sulfides are the alkyltin stabilizers, the alkyl groups are selected from C₁-C₁₂ linear, branched, or cyclic hydrocarbons. Preferably, the alkyl groups are methyl, n-butyl or n-octyl. Preferably, the alkyltin sulfide is a dibutyltin sulfide. Suitable alkyltin mercaptides and alkyltin sulfides are disclosed in U.S. Pat. No. 4,255,320.

The alkyltin compounds can be present in heat stabilizing compositions from 0.1 to 3 parts by weight per 100 parts by weight of chlorine-containing polymers.

### Zeolites

Zeolite co-stabilizers are preferably described by the general formula: M_{x/n}[(AlO₂)ₓ(SiO₂)_{y}]wH₂O, wherein n is the charge of the cation M, M is an element from the first or second main groups of the Periodic Table, such as Li, Na, K, Mg, Ca, Sr or Ba; y and x are numbers that range from 0.8 to 15, preferably from 0.8 to 1.2; and w is a number from 0 to 300, preferably from 0.5 to 30. Examples of zeolites include sodium aluminosilicates of the following types: zeolite A, zeolite Y, zeolite X, zeolite LSX; or the zeolites prepared by complete or partial replacement of the Na atoms by K, Mg, Ca, Sr, or Zn atoms. The preferred Si/Al ratio is about 1:1. Preferred zeolites are Na zeolite A and Na zeolite P. The zeolites are used in an amount from 0.1 to 10.0 parts by weight based on 100 parts of chlorine-containing polymers.

### Other Additives

Optionally, the PVC compounds may also include one or more additives to enhance or modify chemical or physical properties, such as heat stability, lubricity, color, viscosity. Exemplary additives include, but are not limited to, plasticizers, lubricants, viscosity control agents, UV absorbers, antioxidants, methyl methacrylate (MMA)-based co-polymer processing aids, impact modifiers, antistatic agents, antimicrobials and antifungal compounds, fillers, fusion promoters, pigments, flame retardants, smoke suppressants, chemical foaming agents, reinforcing agents, metal release agents, dispersants among other compounds conventionally used in rigid PVC formulations. These additives may be added to the chlorine-containing resins using techniques and equipment well known to those of ordinary skill in the art. An overview of these can be found in Plastics Additives Handbook, 4th edition, editors: R. Gächter and H. Müller, associate editor: P. P. Klemchuk; Hanser Publishers, Munich, (1993) and Plastics Additives and Modifiers Handbook, ed. J. Edenbaum; Van Nostrand Reinhold, (1992), which are incorporated by reference herein in their entirety.

### Lubricants

Suitable lubricants are selected from fatty acids, fatty alcohols, montan wax, fatty acid esters, polyethylene waxes, amide waxes, chloroparaffins, glycerol esters, alkaline earth metal soaps, fatty ketones, or mixtures thereof. Preferably, the lubricant is stearic acid. The lubricants can be present in amounts from 0.1 to 0.5 parts by weight, based on 100 parts by weight of PVC.

### MMA-Based Processing Aids

The conventional processing aids commonly consist of acrylate-methyl methacrylate co-polymers. Its molecular weight varies from 1.5×10⁶ to 6×10⁶ Daltons; preferably from 2.0×10⁶ to 5.0×10⁶ Daltons. Their particle size ranges from 45 to 250 microns, and bulk density ranges from 0.4 to 0.5 g/cm³.

### Fillers

Suitable fillers are selected from calcium carbonate, dolomite, wollastonite, magnesium oxide, magnesium hydroxide, silicates, china clay, talc, glass fibers, glass beads, wood flour, mica, metal oxides or metal hydroxides, carbon black, graphite, rock flour, heavy spar, glass fibers, talc, kaolin, chalk, or mixtures thereof. The fillers can be present in amounts of 1 to 100 parts by weight, more preferably in amounts of 1 to 40 parts by weight and most preferably in amounts of 10 to 30 parts by weight, based on 100 parts by weight of PVC or its copolymers.

### Pigments

Suitable pigments are selected from TiO₂, pigments based on zirconium oxide, BaSO₄, and zinc oxide (zinc white) or mixtures thereof. The pigments can be present in amounts of 1 to 20 parts by weight, based on 100 parts by weight of PVC or its copolymers.

### Antioxidants

Suitable antioxidants are selected from alkylated monophenols such as 2,6-di-tert-butyl-4-methylphenol, alkylthiomethylphenols, 2,4-dioctylthiomethyl-6-tert-butylphenol; alkylated hydroquinones such as 2,6-di-tert-butyl-4-methoxyphenol; hydroxylated thiodiphenyl ethers such as 2,2′-thiobis(6-tert-butyl-4-methylphenol); alkylidenebisphenols such as 2,2′-methylene-bis(6-tert-butyl-4-methylphenol); benzyl compounds such as 3,5,3′,5′-tetratert-butyl-4,4′-dihydroxydibenzyl ether; hydroxybenzylated malonates, such as dioctadecyl 2,2-bis(3,5-di-tert-butyl-2-hydroxybenzyl)malonate; hydroxybenzyl aromatics such as 1,3,5-tris(3,5-di-tert-butyl-4-hydroxybenzyl)-2,4,6-trimethylbenzene; triazine compounds such as 2,4-bisoctylmercapto-6-(3,5-di-tert-butyl-4-hydroxyanilino)-1,3,5-triazine; phosphonates and phosphonites such as dimethyl 2,5-di-tert-butyl-4-hydroxybenzylphosphonate; acylaminophenols such as 4-hydroxylauranilide; esters of β-(3,5-ditert-butyl-4-hydroxyphenyl)propionic acid such as pentaerythritol tetrakis(3-(3,5-di-tert-butyl-4-hydroxyphenyl)propionate), octadccyl-3-(3,5-di-tert-butyl-4-hydroxyphenyl)propionate, β-(5-tert-butyl-4-hydroxy-3-methylphenyl)propionic acid, and β-(3,5-dicyclohexyl-4-hydroxyphenyl)propionic acid; esters of 3,5-ditert-butyl-4-hydroxyphenylacetic acid with mono- or polyhydric alcohols; amides of β-(3,5-ditert-butyl-4-hydroxyphenyl)propionic acid such as N,N′-bis(3,5-ditert-butyl-4-hydroxyphenyl-propionyl)hexamethylenediamine; vitamin E (tocopherol) and derivatives or mixtures thereof.

The antioxidants can be present in amounts of 0.01 to 10 parts by weight, preferably, 0.1 to 5 parts by weight and more preferably from 0.1 to 3 parts by weight, based on 100 parts by weight of PVC.

### UV Absorbers and Light Stabilizers

The UV absorbers and light stabilizers may by selected from 2-(2′-hydroxyphenyl)benzotriazoles such as 2-(2′-hydroxy-5′-methylphenyl)-benzotriazole, 2-hydroxybenzophenones; esters of unsubstituted or substituted benzoic acids such as 4-tert-butylphenyl salicylate and phenyl salicylate; acrylates; nickel compounds; oxalamides such as 4,4′-dioctyloxyoxanilide, and 2,2′-dioctyloxy-5,5′-ditert-butyloxanilide; 2-(2-hydroxyphenyl)-1,3,5-triazines such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine; sterically hindered amines such as bis(2,2,6,6-tetramethylpiperidin-4-yl) sebacate, bis(2,2,6,6-tetramethylpiperidin-4-yl) succinate or mixtures thereof.

### Blending

The components of the rigid PVC compound can be blended by mixing in a mixer or by dry-blending, or by compounding in well-known processes such as extrusion, calendaring, molding and combinations thereof. Compounding of the PVC, mixed metal stabilizer, SAN processing aid and optional additives can also include first blending the components as described above, followed by compounding.

The chlorine-containing polymers with heat stabilizers, processing aids and optional additives can be fabricated into semi-finished goods and articles, including film, sheet, foamed sheet, weatherable exterior, siding capstock and substrate profiles, doors, windows, decking, pipes, roofing, automotive, packaging, medical devices, toys, or waterproofed articles. Such articles can be produced via molding, calendaring or extrusion as discussed above.

### Performance

The above-described stabilized compounds have unexpectedly demonstrated superior operating characteristics relative to conventional processing aids in comparable systems. For the purposes of this specification, the term “conventional processing aids” means methacrylate (MMA)-based co-polymers.

The claimed stabilized compounds containing the SAN processing aids fuse/melt faster than systems containing the conventional compounds, enabling faster throughput. In other words, the claimed stabilized compounds containing processing aids as recited result in a lower/reduced fusing or melting time compared to conventional processing aids in an otherwise identical polymer system. The reduction in fusing or melting time is at least 10° C. at the same processing aid loadings and 180° C. processing temperature The claimed stabilized compound also contains a reduced metal concentration relative to conventional compounds in equivalent systems, demonstrating improved metal utilization. Applicants have unexpectedly discovered that the claimed stabilized compounds exhibit extended heat stability relative to conventional compounds in an otherwise identical polymer system. Because of the improved performance of the claimed processing aids per unit weight, additional operational flexibility is obtained, so that formulators can choose to include lower amounts of the claimed processing aid, relative to conventional compounds with comparable performance. Applicants have also unexpectedly discovered that usage of the claimed stabilized compounds at comparable levels to conventional processing aids and at comparable processing conditions, allows operation at a reduced processing temperature, e.g., by at least 5° C. The claimed stabilized compounds also exhibit enhanced heat stability, while being processed at reduced processing temperatures. The claimed stabilized compounds further exhibit heat stability comparable to conventional compounds while being processed at a reduced processing temperature, even though the claimed stabilized compounds contain lower metal content, while being processed at reduced processing temperature and stabilized by the mixed metal stabilizer added at the reduced loading. The enhanced heat stability of the claimed stabilizer compounds results in reduced discoloration when exposed to UV light and high humidity conditions.

### Examples

The following Examples further detail and explain preparation of the inventive compounds demonstrate their enhanced heat stability and processability. These examples merely illustrate the invention. Those skilled in the art will recognize many variations that are within the spirit of the invention and scope of the claims.

### Raw Materials, Test Methods and Sample Preparation

### Stabilizers

Mark 3252, a solid calcium/zinc stabilizer manufactured by Galata Chemicals.

### Processing Aids

MMA-based conventional process aids (controls): Kaneka PA 20 (Medium Molecular Weight processing aid or MMW PA) manufactured by Kaneka Corporation; Blendex SA106 (High Molecular Weight processing aid or HMW PA) manufactured by Galata Chemicals.

SAN processing aids: Blendex 8633 (Medium Molecular Weight processing aid) and Blendex 8635 (High Molecular Weight processing aid) manufactured by Galata Chemicals.

### PVC Compounding

Components of PVC formulations were compounded, using a Brabender torque rheometer (Plastograph type 815605) according to Tables 1, 2 and 6. The compounds were tested for rheology (fusion time, torques, die swell, drop time) and the dynamic heat stability.

### Dynamic Heat Stability Test Method

PVC dry blend formulations were prepared incorporating the stabilizer and processing aids of this invention described above at the specified amounts expressed in phr of PVC. Each PVC compound test sample (prepared according to formulations described in Table 1) was placed into a Brabender mixer operated at 190° C. and 65 RPM. Sample chips were taken every 3 minutes.

Heat stability of PVC compounds was determined using the microprocessor controlled Hunterlab Labscan Spectro Colorimeter, Type 5100 measuring Yellowness Index (YI) of the sample chips (in accordance with ASTM D 1925-70 Yellowness Index of plastics). Lower YI signifies lower discoloration because of thermal decomposition, and therefore, superior thermal stabilization imparted by a more effective heat stabilizer/process aid package.

### Fusion Time

Fusion time is defined as the difference in time from the sample load point to the fusion maximum. Fusion Time was measured according to ASTM 2538 that specifies a method for fusing a polyvinyl chloride compound using a torque rheometer. C. W Brabender Intelli-Torque Plasti-Corder Rhcometer with a 3-piece mixer, a torque rheometer, was used. Conditions of the test were: 180° C. temperature, 60 rpm rotational speed and 65 g sample size.

Weathering/UV light Stability (QUV Test)

The test compounds were prepared for accelerated UV stability test by compounding dry blend components in a two-roll mill at 177° C. and 30 rpm roll speed. Ten individual rigid sheet specimens were then cut to fit a standard 3″×12″ (3″×5″ actually) panel and secured by snap-in rings. The thickness of the sheets was 30 thou+/−5thou (0.76 mm+/−0.13 mm). The samples were then placed in a QUV Solar Eye accelerated weathering tester (manufactured by Q-Lab Corporation, Westlake, OH) and exposed to conditions under ASTM G-154/Cycle 1 using a 340 nm UVA lamp. The programmed QUV consisted of 8 Hours of UV-light exposure 60° C., followed by 4 Hours of condensation at 50° C. Individual samples were taken at 250-hour intervals and measured for color change (Delta E) using a Hunter ColorQuest II Colorimeter (manufactured by Hunterlab, Reston, VA). The smaller the color change, the more weatherable the compound is.

### Die Swell

The use of process aids in a PVC compound allows for imparting melt strength or melt elasticity to the compound through entanglement of polymeric process aid molecular chains with PVC chains. The entanglement also imbues a die swell to the extrudate. The die swell was experimentally characterized by forming a rod-shaped extrudate, using a lab extruder (Model: C. W. Brabender Intelli-Torque Plasti-Corder Drive with Single Screw Extruder and rod die), cutting it to 12-inch segments and measuring its diameter once the extrudate is cooled to room temperature. The die swell is calculated as the % increase of the diameter of the rod shaped extrudate over the die diameter used.

TABLE 1
Tested PVC compounds

| Components | Function | Loading, phr |
|---|---|---|
| PVC K-67 | Resin | 100.00 |
| Mark 3252 | Stabilizer | Various |
| Blendex SS311 | Impact Modifier | 5.0 |
| Various | Processing Aid | Various |
| Calcium | Filler | 10.0 |
| carbonate(UFT) | | |
| Titanium Dioxide | UV Absorber, pigment | 5.0 |

TABLE 2
Examples of Medium Molecular Weight Processing Aids Testing

| Parameters | Example 1 | Example 2 | Example 3 | Example 4 | Example 5 |
|---|---|---|---|---|---|
| Processing Aid | MMA-based | SAN | SAN | SAN | SAN |
| Processing Aid Loading, phr | 2.0 | 2.0 | 1.8 | 2.0 | 2.0 |
| Processing Temperature, ° C. | 180 | 180 | 180 | 175 | 175 |
| Stabilizer loading, phr | 3.5 | 3.5 | 3.5 | 3.5 | 3.2 |

TABLE 3
Testing of Medium Molecular Weight Processing
Aids (LMW PA) for Fusion Time

| Parameters | Example 1 | Example 2 | Example 3 | Example 4 |
|---|---|---|---|---|
| Fusion Time, sec | 70 | 46 | 72 | 68 |

Conditions: 180° C., 60 rpm, 65 g

The SAN MMW PA (Table 3, Example 2) was found to be more efficient by about 34% than the MMA-based MMW PA control (Table 3, Example 1) in accelerating fusion of the PVC compound stabilized with the calcium-zinc stabilizer. Blendex 8633 enabled the compound fusion time of 46 sec compared to 70 sec by Kaneka PA-20 at the same loading and the process temperature. The demonstrated high efficiency the SAN MMW PA allows using it either at lower loading and at the same process temperature (Table 3, Example 3, where the loading was reduced by 10% from 2.0 phr to 1.8 phr), or at lower process temperature and the same loading (Table 3, Example 4, where the process temperature was reduced from 180° C. to 175° C.), resulting in reduced energy consumption during processing.

TABLE 4
Testing of Medium Molecular Weight Processing
Aids for Die Swell and Drop Time

| Parameters | Example 1 | Example 2 | Example 3 | Example 4 |
|---|---|---|---|---|
| Die Swell, % | 69.9 | 70.5 | 69.1 | 73.7 |

Conditions: 165° C., 40 rpm

Reducing the SAN MMW PA loading by 34% or reducing temperature of the compounding process by 5° C. does not affect processability of the compounds. The compounds reasonably maintained their imparted Die Swell (Table 4, Examples 1-4)

TABLE 5
Testing of Medium Molecular Weight Processing Aids for
Dynamic Heat Stability (expressed in Yellowness Index)

| Time, min. | Example 1 | Example 2 | Example 3 | Example 4 | Example 5 |
|---|---|---|---|---|---|
| 0 | 14.72 | 14.21 | 14.06 | 13.54 | 14.14 |
| 3 | 14.72 | 14.21 | 14.06 | 13.54 | 14.13 |
| 6 | 20.12 | 20.28 | 20.12 | 19.90 | 20.25 |
| 9 | 23.01 | 23.23 | 23.14 | 22.35 | 20.39 |
| 12 | 25.65 | 26.01 | 25.67 | 24.64 | 22.58 |
| 15 | 29.28 | 30.36 | 29.32 | 26.98 | 27.22 |
| 18 | 45.69 | 47.97 | 43.61 | 31.19 | 49.23 |
| 21 | 65.76 | 65.97 | 68.48 | 46.22 | 63.65 |

Conditions: 210° C., 70 rpm

Use of the MMA-based MMW PA control resulted in dynamic heat stability (Table 5, Example 1) comparable to that of SAN MMW PA at the same loading (Table 5, Example 2) and at the loading reduced by about 34% (Table 5, Example 3). However, reduction in the processing temperature by 5° C. (enabled due to higher efficiency of the SAN MMW PA) resulted in the reduced discoloration of the PVC compound (Table 5, Example 4—see the reduced Yellowness Index values after 6 min.) and enabled reducing the amount of the heat stabilizer by at least 9% from 3.5 phr to 3.2 phr (Table 5, Example 5—Yellowness Index values are comparable-to-lower than that of Example 1 and Example 2 throughout the test).

TABLE 6
Examples of High Molecular Weight Processing Aids (MMW PA) Testing

| Parameters | Example 6 | Example 7 | Example 8 | Example 9 | Example 10 |
|---|---|---|---|---|---|
| Processing Aid | MMA-based | SAN | SAN | SAN | SAN |
| Processing Aid loading, phr | 2.0 | 2.0 | 1.7 | 2.0 | 2.0 |
| Processing Temperature, ° C. | 180 | 180 | 180 | 175 | 175 |
| Stabilizer loading, phr | 3.5 | 3.5 | 3.5 | 3.5 | 3.2 |

TABLE 7
Testing of High Molecular Weight Processing
Aids for Fusion/Melting Time

| Parameters | Example 6 | Example 7 | Example 8 | Example 9 |
|---|---|---|---|---|
| Fusion Time, sec | 72 | 58 | 70 | 74 |

Conditions: 180° C., 60 rpm, 65 g

The SAN HMW PA (Table 7, Example 7) was found to be more efficient by about 19% than the MMA-based MMW PA control (Table 7, Example 6) in accelerating fusion of the PVC compound stabilized with the calcium-zinc stabilizer. Blendex 8635 enabled the compound fusion time of 58 sec compared to 72 sec of Blendex SA 106 at the same loading and the process temperature. The demonstrated high efficiency the SAN HMW PA allows using it either at lower loading and at the same process temperature (Table 7, Example 8, where the loading was reduced by 15% from 2.0 phr to 1.7 phr) or at lower process temperature and the same loading (Table 7, Example 9, where the process temperature was reduced from 180° C. to 175° C.), resulting in reduced energy consumption during processing.

TABLE 8
Testing of High Molecular Weight Processing
Aids for Die Swell and Drop Time

| Parameters | Example 6 | Example 7 | Example 8 | Example 9 |
|---|---|---|---|---|
| Die Swell, % | 65.7 | 63.0 | 57.9 | 65.8 |

Conditions: 165° C., 40 rpm

Reducing the SAN HMW PA loading by 19% or reducing temperature of the compounding process by 5° C. does not affect processability of the compounds. The compounds reasonably maintained their imparted Die Swell (Table 8, Examples 6-9)

TABLE 9
Testing of High Molecular Weight Processing
Aids for Dynamic Heat Stability

| Time, | Example | Example | Example | Example | Example |
|---|---|---|---|---|---|
| min. | 6 | 7 | 8 | 9 | 10 |
| 0 | 15.28 | 16.12 | 15.42 | 13.15 | 15.67 |
| 3 | 15.30 | 16.15 | 15.42 | 13.50 | 15.67 |
| 6 | 21.18 | 20.62 | 20.99 | 19.76 | 20.90 |
| 9 | 24.18 | 23.18 | 23.76 | 22.52 | 24.04 |
| 12 | 27.28 | 26.15 | 26.46 | 24.99 | 27.67 |
| 15 | 32.72 | 29.85 | 30.65 | 26.96 | 31.69 |
| 18 | 60.10 | 47.90 | 51.13 | 31.13 | 40.59 |

Conditions: 210° C., 7 rpm

Use of the MMA-based HMW PA control resulted in dynamic heat stability (Table 9, Example 6) comparable to that of SAN HMW PA at the same loading (Table 9, Example 7) and at the loading reduced by about 19% (Table 9, Example 8). However, reduction in the processing temperature by 5° C. (enabled due to higher efficiency of the SAN HMW PA) resulted in the reduced discoloration of the PVC compound (Table 9, Example 9—see the reduced yellowness index values throughout the test from 0 to 21 min. and especially after 12 min.) and enabled reducing the amount of the heat stabilizer by at least 9% from 3.5 phr to 3.2 phr (Table 9, Example 10—Yellowness Index values are comparable-to-lower than that of Example 6 and Example 7 throughout the test).

The calculated nitrogen and metal content of calcium and zinc, as well as the total metal content contributed by the heat stabilizer to the exemplary compounds and nitrogen-to zinc atomic ratio are shown in Table 10.

TABLE 10
Calculated Nitrogen content contributed by SAN PA and Metal content
contributed by the stabilizers of the tested compounds

| Content | Example 1 | Example 5 |
|---|---|---|
| Nitrogen, % | 0 | 0.101 |
| Calcium, % | 0.025 | 0.023 |
| Zinc, % | 0.054 | 0.050 |
| Total, % | 0.079 | 0.073 |
| Metal content | NA | 8.35 |
| reduction, % | | |
| N/Zn Atomic ratio | 0 | 9.48 |

Examples in Table 10 demonstrate that use of the heat stabilizer at the reduced loading of 3.2 phr in combination with the SAN processing aids of Example 5 resulted in the reduced by 8.35% calculated total metal content of the tested compounds compared to the Example 1 control. Table 10 also shows that nitrogen-to-zinc atomic ratio of the compound in Example 5 equals to 9.48.

We claim:

1. A stabilized compound comprising:
a) a resin comprising PVC or its copolymers;
b) 0.1 to 10 parts by weight of a styrene-co-acrylonitrile (SAN) processing aid comprising nitrogen based on the weight of the resin; and
c) 0.1-10 parts by weight of a mixed metal heat stabilizer per 100 parts by weight of the resin, the stabilizer comprising a zinc compound and at least one metal compound where the metal is selected from Na, K, Mg, Ca, Sr, Ba, Cd, Al, La, Ce or rare earth metals, based on 100 parts of the resin,
wherein an atomic ratio of nitrogen from the SAN processing aid to zinc from the stabilizer in the compound ranges from 0.03 to 300.

2. The compound of claim 1 wherein the atomic ratio is from 1.5 to 15.

3. The compound of claim 1, where the SAN processing aid comprises about 71-75% styrene and about 25-29% acrylonitrile.

4. The compound of claim 1, wherein the mixed metal stabilizer comprises barium and zinc, magnesium and zinc, calcium and zinc, or calcium, magnesium and zinc.

5. The compound of claim 1, wherein the zinc and metal compounds are independently selected from carboxylates, overbased carboxylates, glycerolates, hydroxides, phosphites, or benzoates

6. The compound of claim 5 wherein the carboxylates are independently selected from oleates, stearates, palmitates, soyates, tallates, myristylates, hydroxystearates, dihydroxy-stearates, laurates, 2-ethylhexanoates or salts of shorter-chain alkanecarboxylic acids.

7. The compound of claim 6 wherein the zinc and metal carboxylates are selected from carboxylates of carboxylic acids having 7 to 18 carbon atoms.

8. The compound of claim 1, wherein the mixed metal stabilizer is present in an amount from 0.5 to 5.0 parts by weight per 100 parts by weight of PVC or its copolymers.

9. The compound of claim 1, wherein the mixed metal stabilizer further comprises a co-stabilizer selected from zeolites, hydrotalcites, alkyltin compounds, and mixtures thereof.

10. The compound of claim 1, wherein the compound fuses/melts faster than acrylate-methyl methacrylate co-polymers.

11. The compound of claim 1, wherein the compound exhibits increased heat stability relative to acrylate-methyl methacrylate co-polymers.

12. A process for preparing a stabilized compound comprising mixing:
a) a resin comprising PVC or its copolymers;
b) 0.1 to 10 parts by weight of a styrene-co-acrylonitrile (SAN) processing aid comprising nitrogen based on the weight of the resin; and
c) 0.1-10 parts by weight of a mixed metal heat stabilizer per 100 parts by weight of the resin, the stabilizer comprising a zinc compound and at least one metal compound where the metal is selected from Na, K, Mg, Ca, Sr, Ba, Cd, Al, La, Ce or rare earth metals, based on 100 parts of the resin,
wherein an atomic ratio of nitrogen from the SAN processing aid to zinc from the stabilizer in the compound ranges from 0.03 to 300.
